(19) United States
(12) Patent Application Publication
(10) Pub. No.: US 2009/0017791 A1
(43) Pub. Date: Jan. 15, 2009

(54) INTERACTIVE COMMUNICATION DEVICE

(75) Inventor: Bernard Besson, Villaz (FR)

Correspondence Address: WILLIAM H. EILBERG, 316 CALIFORNIA AVE. #785, RENO, NV, 89509, US

(73) Assignees: Bruno Gros, Ecully (FR); Edouard Labruhe, Groot Bijgaarden (BE)

(21) Appl. No.: 12/237,654

(22) Filed: Sep. 25, 2008

Related U.S. Application Data
(63) Continuation-in-part of application No. 10/512,751, filed on Oct. 27, 2004.

(30) Foreign Application Priority Data
Apr. 3, 2002 (FR) 02 04367

(51) Int. Cl. H04M 1/66

(52) U.S. Cl. 455/411

(57) ABSTRACT

A server system is connected to a number of remote displays for messages for broadcasting by a communication network. The audiovisual messages received from the server system are made perceptible for customers. The customers can send coded instruction signals to a first access device, located near a display, by portable customer badges, which are transmitted to the server system which then establishes a back-up communication with the customer, for example, through a portable telephone. The customer can thus simply establish communication and, when the server system has information specifically concerning the above, the information need not be transmitted over the network.

### CROSS-REFERENCE TO PRIOR APPLICATION

This is a continuation-in-part of U.S. patent application Ser. No. 10/512,751, filed Oct. 27, 2004, which is the national phase of International Application No. PCT/FR2003/001031.

### BACKGROUND OF THE INVENTION

The present invention concerns devices for setting up calls between a customer and a service provider for communicating information to the customer and for transmitting orders to the service provider.

The customer generally receives advertising information from the service provider in the form of printed paper, advertising posters, or even broadcast advertising on a display screen. The customer must then choose a subject of interest from the received advertisements and enter into communication with the service provider to request additional information, place a purchase order, or perform any other activity. In setting up his call, the customer must provide a great deal of information, including in particular a description of the subject of interest, a statement of his intentions and his instructions, and an indication of the means of payment in the case of a purchase order, in addition to his civil status and the delivery address, his banking details, and proof of his ability to pay.

If the call set up by the customer to the service provider uses the worldwide network for communication between computers, the payment data must additionally be made secure to prevent it from being misused by third parties.

All of this complicates the operations to be performed by the customer, which slows down commercial transactions and increases the risk of error.

More recently there has been envisaged a simplified purchase order transmission system whereby the service provider stores most of the information relating to the customer and sends the customer audiovisual messages including an order button which the customer may click to send a signal to the service provider, which generates the order itself. This limits information in transit on the network and facilitates the operations to be performed by the customer. However, the system is suitable only for placing an order and the messages that the service provider must transmit comprise an order instruction button and are therefore specific and more complex.

### SUMMARY OF THE INVENTION

The object of the present invention is to provide a new interactive communication device that facilitates the operations to be executed by the customer, facilitates the broadcasting of audiovisual messages from the service provider(s) to customers, enables customers easily to locate products or services, or service providers to contact potential customers, limits the volumes of information transmitted over the networks for the various transactions, and is compatible with transactions that are more complex than a simple purchase instruction.

In particular, the invention must enable the customer to choose and trigger transactions merely by actuating a badge, without having to provide and transmit confidential information and without using a bank card with a PIN.

At the same time, the invention must make the transaction secure, to prevent a third party from interfering with certain transactions.

To achieve the above and other objects, an interactive communication device of the invention comprises:
at least one server system having storage means containing an area for information relating to a plurality of customers, an area for audiovisual broadcast messages, and an interactive communication program,
a plurality of means for displaying audiovisual broadcast messages, located remotely from the server system,
a communication network, adapted to transmit audiovisual broadcast messages chosen by the program from the server system to the display means,
at least one first access means, placed in or near one or more associated display means,
at least one mobile customer badge assigned to a customer and adapted, in response to a specific action of the customer or in response to a request by the access means or by the server via the return transmission means 19, to enter into the first access means a coded instruction signal containing a customer identification code and an instruction chosen by the customer from a plurality of possible instructions,
the first access means being adapted to transmit an instruction message that contains the instruction chosen by the customer, the customer identification code, and an identifier of the display means to the server system via the communication network.

In one advantageous embodiment, the display means are screens and electroacoustic transducers for the presentation of audiovisual messages placed in positions making them perceptible by customers.

To enable the customer to choose a specific instruction from a plurality of possible instructions, the mobile customer badge may advantageously comprise an input interface enabling the customer to enter an instruction chosen from the plurality of possible instructions by means of an appropriate specific action.

For example, the mobile customer badge may comprise a plurality of keys each corresponding to a specific instruction and which, when pressed, generate a coded instruction signal containing the corresponding specific instruction.

It may be advantageous for one of the keys to be operable more than once in succession to generate successively an order instruction and then a payment instruction. The same key may also switch on the mobile customer badge. It may be switched off automatically by a timer.

Security may be improved by the mobile customer badge comprising at least one key associated with a fingerprint recognition device and the device comprising means for inhibiting execution of the customer's specific instruction in the event of non-recognition of one or more fingerprints previously stored by the customer.

In a first embodiment:
the mobile customer badge is a magnetic stripe card, optical stripe card or microchip card in which the customer identification code is stored,
the first access means is a card reader adapted to read the customer identification code in the card presented to it.

In another embodiment:
the mobile customer badge comprises an electromagnetic signal sender adapted, in response to a specific action of the customer, to send the coded instruction signal in the form of a coded electromagnetic signal,
the first access means is an electromagnetic signal receiver adapted to receive said coded electromagnetic signal and to extract therefrom the customer identification code and the instruction corresponding to the specific action of the customer.

In the latter case, the mobile customer badge may be a dedicated device. Alternatively, it may be a cellular mobile telephone.

Using a mobile badge of this type can also have great advantages. For example, the manufacturing cost of the display means can be optimized by using the input/output interfaces of the badge (keypad, or even loudspeaker, screen, etc.), or the operating costs of the system can be reduced (less maintenance, fewer cash collections, less vandalism, etc.). Another advantage can be personalization of this type of badge by the customers themselves in order to personalize feedback (badge and/or display means) or the services proposed by the access means (avatar, nickname, preferences, photos, ring tones, games, etc. or customer profile: age, sex, interests, etc.).

For improved communication between the customer and the first access means, it may be advantageous if:
the mobile customer badge is adapted to receive coded electromagnetic request signals from an access means or acknowledgment signals,
the first access means comprises a sender and means for generating and sending an electromagnetic signal to request one or more mobile badges, or to generate an acknowledgment signal after reception of a coded instruction signal coming from the mobile customer badge,
the mobile customer badge is adapted to send a status signal perceptible by the user and indicating if the first access means has received the coded instruction signal correctly. Depending on the embodiment chosen, a status signal or any type of information on the badge itself may be displayed to the best effect in accordance with the technical characteristics of the badge recognized by the server.

To enable the server to call the customer directly via the feedback transmission means 19, the mobile customer badge can also be adapted to receive an incoming message directly from the server via the feedback transmission means 19.

In all the above situations, to establish a link between the audiovisual message perceived by the customer on a display means and the instruction that the customer wishes to give:
a subroutine contained in said program may instruct the server system to store the time of transmission to each display means of each broadcast audiovisual message,
on receiving an instruction message, the program of the server system may combine the specific coded instruction signal, the identifier of the display means, the time of generation of the coded instruction signal, and the remainder of the broadcast messages to determine the broadcast audiovisual message that was being displayed at the time of generation of the coded instruction signal and to deduce therefrom the action to be performed by the return transmission means.

Using their mobile badge, customers can interrogate their environment to find out the nearest display means. Their mobile badge sends a coded electromagnetic signal picked up by the access means within range. Customers could refine this enquiry by preselecting via their badge the type of service or product they are looking for, either automatically (preferences) or by choosing from a predefined list of services or products. The server can also improve the targeting of its response as a function of the customer information that it contains. Another filter can be the distance between the badge and a display means: depending on the embodiment used, the access means will be able either only to give an indication of its distance from the badge or to call the server via the feedback transmission means 19 to find out that distance if the badge has access to geographical location means that the server can use.

In another embodiment, customers interrogate the server directly via the feedback transmission means 19 using their mobile badge (via the telephone network of the cellular telephones, for example) to find out which display means are nearest to them. The response is returned in the same manner from the server to the badge or via the access means concerned.

To make transactions more secure, in particular transactions having a non-negligible economic impact:
the device may comprise return transmission means adapted to set up directly to the customer a follow-up call from the server system or a service provider system designated by the server system,
the program of the server system may be adapted to choose and set up the follow-up call as a function of the coded instruction signal received from the customer and information contained in the area for information relating to a plurality of customers.

The return transmission means may advantageously be the cellular mobile telephone network. The call for requesting more information, confirming an order, instructing shipping or any other transaction is then set up by telephone.

In one particular embodiment, the return transmission means is a means for transmitting text messages, such as the postal service, electronic mail, facsimile, electronic messages. This constitutes an alternative to the cellular mobile telephone.

Other objects, features and advantages of the present invention will emerge from the following brief description of the drawings, the detailed description of the invention, and the appended claims.

### BRIEF DESCRIPTION OF THE DRAWINGS

FIG. 1 shows diagrammatically the architecture of one embodiment of an interactive communication device of the present invention.

FIG. 2 shows the active face of a mobile customer badge used in one embodiment of the invention.

FIG. 3 provides a flow chart illustrating one possible mode of operation of the interactive communication program of the mobile customer badge 14 or 15.

FIG. 4 provides a flow chart illustrating another possible mode of operation of the interactive communication program of the mobile customer badge 14 or 15, in a variant A that enables the access means 5a-7a to call the mobile customer badge 14 or 15.

FIG. 5 provides a flow chart illustrating another possible mode of operation of the interactive communication program of the mobile customer badge 14 or 15, in a variant B that enables the server means 1 to call the mobile customer badge 14 or 15 via the feedback transmission means 19.

FIG. 6 provides a flow chart illustrating another possible mode of operation of the interactive communication program of the mobile customer badge 14 or 15, in an embodiment in which this “basic” badge is a magnetic stripe, optical stripe or smart card.

FIG. 7 provides a flow chart showing one possible mode of operation of the subroutine for preparing a coded instruction signal between a mobile customer badge 14 or 15 and access means 5a-7a regardless of the direction.

FIG. 8 provides a flow chart showing one possible mode of operation of the subroutine for analyzing a coded instruction signal between a mobile customer badge 14 or 15 and access means 5a-7a regardless of the direction.

FIG. 9 provides a flow chart showing one possible mode of operation of the subroutine for interrogation of the server 1 by a mobile customer badge 14 or 15.

FIG. 10 provides a flow chart showing one possible mode of operation of the subroutine for a mobile customer badge 14 or 15 to respond to the server 1.

FIG. 11 provides a flow chart showing one possible mode of operation of the interactive communication program of the access means 5a-7a.

FIG. 12 provides a flow chart showing one possible mode of operation of the interactive communication program of the access means 5a-7a if it includes a card reader for example for communicating with a “basic” mobile customer badge.

FIG. 13 provides a flow chart showing one possible mode of operation of the optional subroutine according to the embodiment chosen for the access means 5a-7a to call a mobile customer badge 14 or 15.

FIG. 14 provides a flow chart showing one possible mode of operation of the interactive communication program of the server 1.

FIG. 15 provides a flow chart showing one possible mode of operation of the subroutine for the customer to make an emergency call by giving an instruction on their mobile customer badge 14 or 15.

FIG. 16 provides a flow chart showing one possible mode of operation of the subroutine for managing valid orders apart from the emergency order.

FIG. 17 provides a flow chart showing one possible mode of operation of the optional subroutine according to the embodiment chosen for the badge to respond to interrogation by the server 1.

FIG. 18 provides a flow chart showing one possible mode of operation of the subroutine for preparing and sending audiovisual messages to the access means 5a-7a.

FIG. 19 provides a flow chart showing one possible mode of operation of the optional subroutine (depending on the embodiment chosen) for calling mobile customer badges near one or more display means 5-7 via transmission means 19.

FIG. 20 provides a flow chart showing one possible mode of operation of the program for sequencing actions effected by the mobile customer badge as a function of the customer pressing the main key 31.

### DETAILED DESCRIPTION OF THE INVENTION

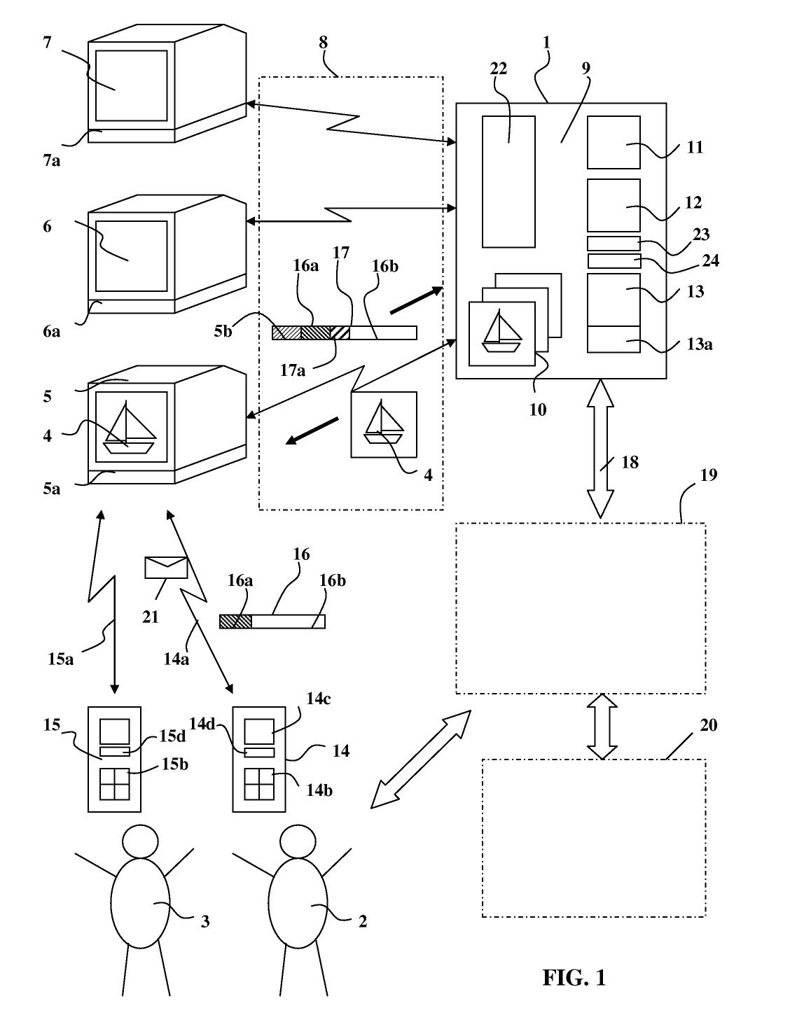

In the embodiment shown in FIG. 1, an interactive communication device of the invention provides communication between a server system 1 and a plurality of customers 2 and 3 shown diagrammatically.

The server system may communicate audiovisual messages 4 to the customers 2 and 3 via a plurality of means for displaying broadcast messages remote from the server system 1, such as the display means 5, 6 and 7. Such broadcast messages may be individual broadcast messages. A communication network 8 transmits audiovisual messages 4 to be broadcast chosen by a program that is stored in storage means 9 of the server system 1 from the server system 1 to the display means 5-7.

In practice, the storage means 9 contains an area 10 for the various broadcast messages, an area 11 for information relating to a plurality of customers, an area 12 for information relating to the means for displaying broadcast messages, an area 23 for technical characteristics of all the badges (described below), an area 24 for customer identification code stacks of each mobile customer badge (described below), and an interactive communication program 13 that controls a central unit 22.

As used in this specification, the term “interactive communication program” includes a programmable device (such as a microprocessor) which is programmed to perform the functions of the interactive communication program described in this specification.

The communication network comprises means for transmitting broadcast audiovisual messages chosen by the interactive communication program, from the server system, to the means for displaying individual broadcast messages.

Each display means 5-7 is associated with a display means identifier that identifies it unambiguously.

The device further comprises at least one first access means 5a, 6a or 7a in the vicinity of an associated display means 5, 6 or 7. The first access means 5a-7a is adapted to receive from a customer 2 or 3 an instruction signal that it then transmits to the server system 1 via the communication network 8.

Each customer 2 or 3 may be provided with his own respective mobile customer badge 14 or 15.

Each mobile customer badge 14 or 15 is adapted, in response to a specific action of the customer 2 or 3, to enter into the first access means 5a-7a a coded instruction signal 16 chosen by the customer 2 or 3 and containing a customer identification code 16a extracted from a stack of customer identification codes stored in a respective storage means 14d or 15d and a specific instruction 16b taken from a plurality of possible instructions.

The badge therefore comprises means for entering into the first access means an instruction signal coming from the customer in response to a specific action of the customer. The badge also comprises an input interface which enables the customer to enter an instruction chosen from a plurality of possible instructions by an appropriate specific action.

The first access means 5a-7a comprises means for transmitting said coded instruction signal 16 to the server system 1 in the form of an instruction message 17 that contains the customer's instruction 16b, the customer identification code 16a, and additionally, in an area 5b, the identifier of the corresponding display means 5-7.

After receiving an instruction message 17, the server system 1 either executes the customer's instruction or starts by setting up a follow-up call 18 to the customer 2 or 3 via a return transmission means 19. The return transmission means 19 is adapted to set up directly a follow-up call to the customer 2 or 3 from the server system 1 or a service provider system 20 designated by the server system 1.

The program 13 of the server system 1 chooses and sets up the follow-up call 18 as a function of the coded instruction signal 16 received from the customer 2 or 3 in the instruction message 17: the program 13 finds in the coded instruction signal 16 the customer identification code 16a and may then extract the telephone coordinates of the customer concerned from the area 11 for information relating to the plurality of customers and use that information to instruct the return transmission means 19 to set up the follow-up call 18; the program 13 also finds the customer's instruction 16b in the coded instruction signal 16 and may then extract from the area 11 for information relating to the plurality of customers the additional data needed for following up the customer's instruction, for example credit data or authorizations needed to progress the customer's instruction.

The device of the invention is preferably programmed to manage less important transactions and more important transactions differently. Accordingly, the program 13 of the server system may be adapted to launch execution of the customer's specific instruction 16b directly, without setting up a follow-up call 18, if the instruction 16b involves a financial transaction in an amount below a predefined threshold. On the other hand, if the customer's specific instruction 16b involves a financial transaction in an amount above the predefined threshold, then the program 13 of the server system sets up the follow-up call 18 in order to verify the real intentions of the customer.

In the case of a follow-up call 18, it is advantageous for the server system 1 to comprise a voice recognition device associated with the return transmission means 19 and means for inhibiting execution of the specific instruction 16b in the event of non-recognition of the prerecorded voice of the customer 2 or 3.

The instruction message 17 may advantageously further include an area 17a containing an indication of the time at which the coded instruction signal 16 was sent. This enables a link to be established with the audiovisual message 4 that was being perceived by the customer 2 or 3 at the time he generated the coded instruction signal 16. To this end, the program 13 stored in the storage means 9 of the server system 1 comprises a subroutine 13a that instructs the server system 1 to store the time of transmission to each display means 5-7 of each broadcast audiovisual message 4.

For example, the display means 5-7 may be screens and electroacoustic transducers for presentation of audiovisual messages placed in positions making them perceptible by the customers 2 and 3. For example, the screen and electroacoustic transducers may be those of a conventional television set, a multimedia computer, a display panel, a product display, or any other equivalent device.

The display means 5-7 may be installed in public places, for example, or in customers' homes, and may be connected to the server system 1 via the communication network 8, in particular via the worldwide network for communication between computers, satellite, the switched telephone network, dedicated lines, the fiber optic cable network, wireless means or any other means.

The mobile customer badge 14 or 15 may also itself constitute a display means.

In a first embodiment, the mobile customer badge 14 or 15 may be a magnetic stripe card, an optical stripe card or a microchip card in which the customer identification code 16a is stored and which comprises at least one key for the customer to choose the specific instruction 16b to send, for example. The first access means 5a-7a may then comprise a card reader adapted to read the customer identification code 16a in the card 14 or 15 that is presented to it. To transmit an instruction to the server system 1, the customer 2 or 3 must then present his card 14 or 15 to the reader of the first access means 5a-7a and choose the specific instruction 16b.

In a preferred embodiment, the mobile customer badge 14 or 15 may comprise an electromagnetic signal sender adapted to send the coded instruction signal 16 in the form of a coded electromagnetic signal 14a or 15a in response to the actuation of a key 14b or 15b by the customer 2 or 3. The first access means 5a-7a then comprises an electromagnetic signal receiver adapted to receive said coded electromagnetic signal 14a or 15a and to extract from it the customer identification code 16a and the instruction 16b corresponding to the key 14b or 15b operated by the customer 2 or 3.

In another preferred embodiment, access means 5a-7a can comprise an electromagnetic signal sender adapted to send an information signal to the customer 2 or 3. This informs the customer 2 or 3 of the presence of display means 5-7. The access means 5a-7a can advantageously filter calls to the customers 2 or 3 as a function of the customer information area 11 or the proximity of the customers 2 or 3 to the display means 5-7. That distance can be determined either from geographical location information from the mobile badge 14 or 15 processed by the server 1 or the access means 5a-7a or from distance information obtained by analyzing the electromagnetic signal.

Depending on the applications envisaged, other access means 5a-7a may comprise a cash register, a coin or banknote dispenser, an automaton, a telephone.

The access means 5a-7a may itself be a mobile customer badge 14 or 15.

The mobile customer badge 14 or 15 preferably comprises a plurality of keys, for example four keys as shown in the figure, each corresponding to a specific instruction and generating a coded instruction signal 16 containing a specific instruction.

For example, if the customer 2 presses a key 14b that causes the sending of a coded purchase instruction signal 16 to an access means 5-7 and then the instruction message 17 of the access means 5-7 to the server 1, the system associates the instruction message 17 with the audiovisual message 4 perceived by the customer 2 or 3 at the time he pressed the key 14b. Thus the server system 1 interprets the instruction message 17 as a purchase instruction relating to an object appearing on the screen 5 for which the first access means 5a has received the coded instruction signal 16 sent by the customer 2, for example. Where applicable, on receiving this instruction, the server system 1 sets up a follow-up call 18 to the customer 2 via the return transmission means 19.

For example, the return transmission means may be a means for transmitting text messages, such as the postal service, electronic mail, facsimile, electronic messages on cellular telephones. This transmission mode is suitable if the messages to be transmitted are relatively simple and do not have to be transmitted particularly quickly.

A return transmission means in the form of a cellular mobile telephone network may nevertheless be preferred. Direct communication with the customer 2 or 3 is then more reliable, and in this case it is advantageous to use the same, and appropriately programmed, cellular mobile telephone as the mobile customer badge 14 or 15.

In all situations in which the mobile customer badge 14 or 15 is adapted to emit electromagnetic signals, for example in the case of a cellular mobile telephone or an appropriate sender, it may be advantageous to provide means for displaying the transmission status. In this case, the mobile customer badge 14 or 15 may advantageously be adapted to receive electromagnetic acknowledgment signals sent by the first access means 5a-7a. To optimize display by the customers 2 or 3 of this status on their mobile badge 14 or 15, the server 1 can use the technical characteristics of the badges stored in its area 23. To this end, the first access means 5a-7a comprises a sender and means for generating and sending an electromagnetic acknowledgment signal 21 after a coded instruction signal 16 is received from the mobile customer badge 14 or 15. At the same time, the mobile customer badge 14 or 15 sends a status signal 14c perceptible by the user and indicating whether the first access means 5a-7a has received the coded instruction signal 16 correctly.

For example, the mobile customer badge 14 or 15 may be programmed to send a “Received OK” status signal 14c if it has received the electromagnetic acknowledgment signal 21 shortly after the coded instruction signal 16 is sent or a “Not received OK” status signal 14c if it has not received the electromagnetic acknowledgment signal 21 within a predetermined time after a coded instruction signal 16 is sent.

The benefit of all embodiments of the invention is to enable the customer 2 or 3, merely by actuating his mobile customer badge 14 or 15, to give to the server system 1 sufficient specific instructions to perform a complex transaction such as a purchase and payment instruction, a request for more information, a shipping request, or various other services that may be provided by associated service providers.

It may further be advantageous for the mobile customer badge 14 or 15 to comprise an RPT key and storage means for temporarily storing the coded instruction signal 16 until an electromagnetic acknowledgment signal 21 is received: if the electromagnetic acknowledgment signal 21 is not received, as soon as a “Not received OK” status signal 14c is sent, the RPT key is activated and the user may operate it to send the stored coded instruction signal 16 again. In particular, this facility solves the problems of collisions in the event of simultaneous sending of a plurality of coded instruction signals from a plurality of mobile customer badges 14 and 15 to the same first access means 5a.

Each means 5-7 for displaying broadcast messages may comprise a private surveillance video camera fixed above the screen, a small monitor or monitoring screen receiving images from the video camera, a sensor for detecting persons in the vicinity, and a plurality of first access means such as the first access means 5a.

The electromagnetic acknowledgment signal 21 may comprise an identity code of the first access means 5a-7a that sent it. This code may be displayed on the mobile customer badge 14 or 15.

The server system 1 may be programmed to set up quickly the follow-up call 18. Alternatively, the server system 1 may be programmed to defer setting up the follow-up call 18, thereby guaranteeing discretion or confidentiality.

A plurality of interactive sub-badges may be associated with a main mobile customer badge 14 or 15, for example issued to members of the same family.

Instead of this, or in addition to this, a plurality of customers may use the same mobile customer badge in succession. In this case, a biometric recognition means are preferably provided, such as a fingerprint recognition means, to inhibit the operation of the badge in the event of failure to recognize one of the prestored fingerprints, and the coded instruction signal 16 may contain the chosen instruction 16b, the customer identification code 16a, and an identification code of the mobile customer badge 14 or 15.

In the case of a mobile customer badge 14 or 15 in the form of a cellular mobile telephone, the cellular mobile telephone may advantageously be programmed to provide an encrypted access code, voice recognition to recognize the timbre of the voice of the usual customer, a personalized pseudonym, fingerprint recognition.

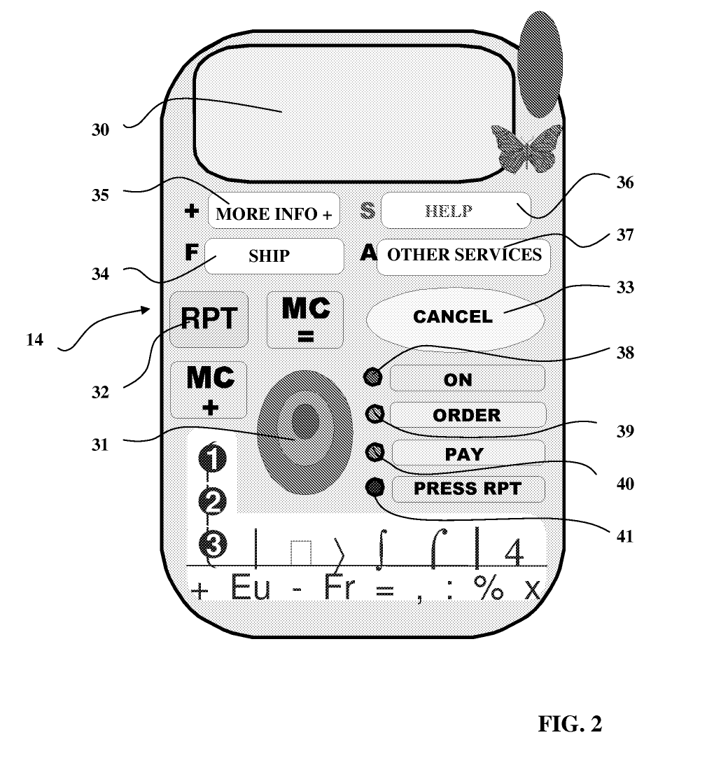

FIG. 2 shows one example of a mobile customer badge.

This mobile customer badge 14 takes the form of a calculator type unit comprising a display screen 30, which may be replaced with light-emitting diodes, and in particular a main key 31, an RPT key 32, a CANCEL key 33, a SHIP key 34, a MORE INFO key 35, a HELP key 36, and an OTHER SERVICES key 37.

The main key 31 constitutes, firstly, means for actuating the interface and, secondly, means for recognizing the fingerprint of the operator. The fingerprint of the customer is stored beforehand, either in the mobile customer badge or in the server system 1 if the corresponding information may be securely transmitted (with encryption, for example) with the customer's instruction.

Pressing the main key 31a first time switches on the mobile customer badge, and where applicable turns on a first light-emitting diode 38. Pressing the main key 31 again sends an order instruction and turns on a second light-emitting diode 39. Pressing the main key 31 again sends a payment instruction and turns on a third light-emitting diode 40.

A greater number of dedicated instructions may be provided by assigning certain dedicated instructions a combination of keys to be actuated simultaneously or in succession.

If the mobile customer badge 14 does not receive an acknowledgment of the instruction that has been sent to the nearby access means, the mobile customer badge generates a visual message by turning on a diode 41, prompting the customer to press the RPT key 32 to generate the instruction again.

Note that the fingerprint recognition device may be replaced by any other biometric recognition means.

It may be useful to modify the customer identification code 16a periodically. One option is as follows:
the mobile customer badge 14 or 15 contains a stack of customer identification codes stored in a random order in a memory 14d or 15d of the badge 14 or 15,
the server system 1 contains the same stack of customer identification codes stored in the same random order in a memory of the server within the area 24 containing the stacks of customer identification codes for all the badges,
with each dedicated instruction 16b that the customer decides to send, the mobile customer badge 14 associates the next higher customer identification code 16a in the stack of customer identification codes within the badge memory 14d or 15d,
on each reception of an instruction message 17, the server system 1 compares the customer identification code 16a received with the next higher customer identification code in its own stack of customer identification codes in the area 24 and inhibits execution of the customer's dedicated instruction 16b if they are different. It can also be assigned a tolerance by the server 1 of a few customer identification codes of immediately next higher rank in its own stack of customer identification codes, which would authorize an offset of a few customer identification codes caused by communication problems, for example. Should the server 1 find a code identical to the code 16a, it will validate the instruction and keep a record of the fact that the new valid customer identification code is not the immediately higher one in its own stack of customer identification codes, but the identical one that respects the offset tolerance of a few codes.

As a security measure, the customer identification code stack can also be stored in each mobile badge 14 or 15 in the area 14d or 15d and by the server for all of the mobile badges in the area 24, either during manufacture of a badge or a posteriori, in either case by a trusted third party.

Another option is for the coded instruction signals 16 and/or the instruction messages 17 to be encrypted using from 128 to 448 bits and keys distributed in a random selection mode with the rate of distribution of keys modifiable and adjustable.

The operation of the device of the invention may be summarized in the following manner in the case of an order instruction.

When he sees on the display means 5 an audiovisual message 4 of interest, the customer 2 presses the key 14b relating to an order instruction. The mobile customer badge 14 then sends a coded instruction signal 16 to the first access means 5a. Either immediately or later, the first access means 5a generates an instruction message 17 that is sent to the server system 1, which verifies the data of the message: it verifies the customer identification code 16a against the area 11 for information on the plurality of customers, it verifies the identifier of the display means 5b against the area for means for displaying broadcast messages 12, and it searches for the audiovisual message 4 in the area 10 for broadcast messages as a function of the time at which the coded instruction signal 17a was generated. Immediately or later, the server system 1 then generates a telephone call to the mobile telephone 14 of the customer 2 to validate the order, program shipment and on-line follow-up, and record the total payment.

When he presses a dedicated key to send an information request message, the mobile customer badge 14 of the customer 2 generates a different dedicated coded instruction signal that is transmitted to the server system 1 in the same way and is interpreted by the server system 1 in order to set up quickly a follow-up call 18 for transmitting the required information to the customer.

A similar mode of operation may be provided for the situation where the customer 2 presses a key relating to a shipping instruction.

If the customer 2 presses a key for another service, the server system 1 interprets the signal received to set up a call between a service provider system 20 and the customer 2.

Giving the device an additional help function may be envisaged. To this end, a dedicated key on the mobile customer badge 14 is assigned, actuation of this key generating a dedicated coded instruction signal 16 that is received by the server system 1, which immediately generates a telephone call to the mobile telephone of the customer 2. If it is not possible to set up the call, then the server system 1 generates a telephone or fax call or an electronic mail that is transmitted directly to the law enforcement agency nearest the first access means 5a-7a that has received the signal from the customer 2. The message sent to the law enforcement agency contains full information on the customer and the geographical location of the access means 5a-7a, or where appropriate directly from the customer if the server has access to geographical location information for the mobile customer badge used, in order for intervention to be expedited immediately to the appropriate place and as quickly as possible.

In summary, the interactive communication program, contained in the storage means, comprises means for combining the coded instruction signal, the identifier of the displaying means, the time of generation of the coded instruction signal, and a remainder of the broadcast messages, to determine the broadcast audiovisual message that was being displayed at the time of generation of the coded instruction signal, and to deduce therefrom an action to be performed.

Also, the dedicated key comprises means for generating a dedicated coded instruction signal to the server system, and the server system comprises means for contacting the customer, and for sending a message to a law enforcement agency nearest the first access means with information about the customer and the location of the first access means, in the event that the customer does not respond to the server system.

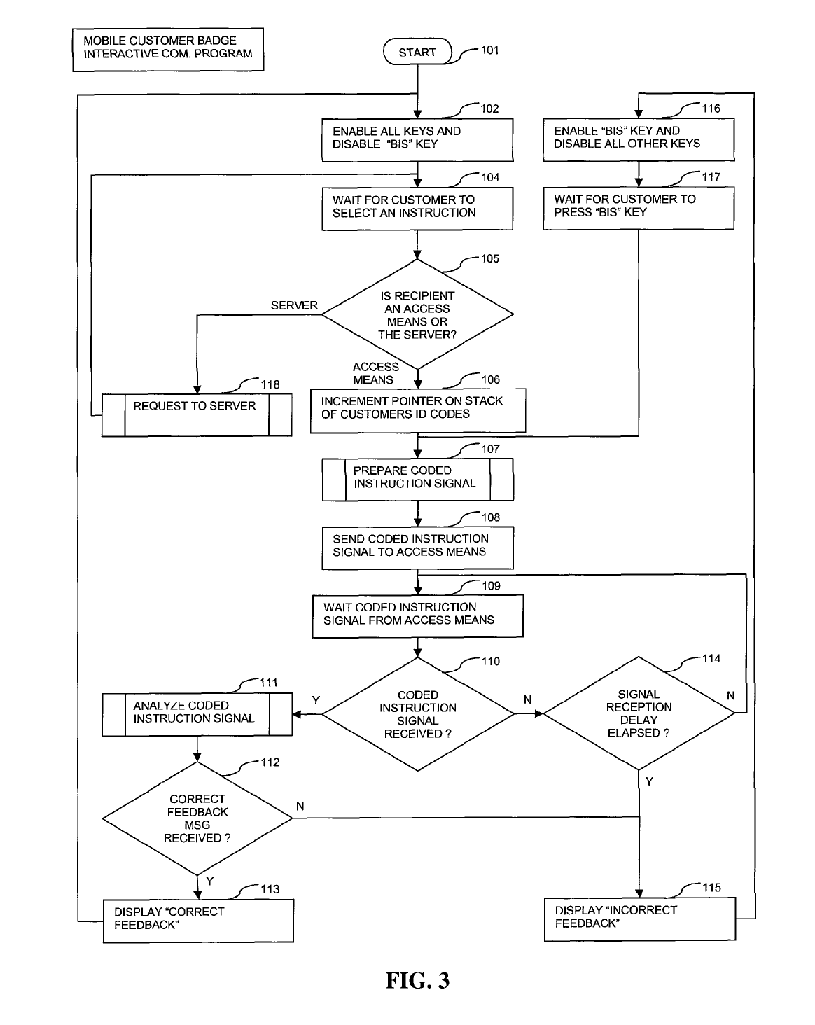

FIGS. 3-20 comprise flow charts illustrating the programming implied in the components shown in FIGS. 1 and 2. The following is a detailed description of such programming.

FIG. 3 shows the programming of the mobile customer badge 14 or 15.

In step 102, all of the keys of the mobile customer badge keypad 14 are activated except for the “BIS” key. Where appropriate, check that light-emitting diodes are off.

In step 104, wait for an instruction from customer 2 or 3 via a keypad key 14b.

In step 105, test addressee of the customer instruction: server 1 or access means 5a-7a. If the server 1 is the recipient of the customer instruction, then go to step 118.

In step 106, the access means 5a-7a is the recipient of the customer instruction. Then, indicate that the next customer identification code 16a will be the immediately next higher code in the stack of customer identification codes 14d, 15d. This prepares for the next call with the server 1 via the access means 5a-7a.

In step 107, call the coded instruction signal preparation subroutine.

In step 108, send the coded instruction signal 16 to access means 5a-7a.

In step 109, wait for feedback signal 21 from access means 5a-7a.

In step 110, test for reception of a feedback signal 21 from access means 5a-7a. If no feedback signal from the access means 5a-7a has yet been received, go to step 114.

In step 111, if a feedback signal 21 from the access means 5a-7a has been received, invoke the subroutine for analyzing this signal.

In step 112, test the validity of feedback message 21 received. If the feedback message indicates that the preceding message from the badge 14 to the access means 5a-7a was received incorrectly, go to step 115.

In step 113, if the feedback message 21 indicates that the preceding message from the badge 14 to the access means 5a-7a was correctly received, display it on the badge 14 by sending a status signal 14c “CORRECT FEEDBACK”. Where appropriate, an access means 5a-7a code can also be displayed, and even audiovisual messages 4. The program then reverts to a state awaiting a new instruction (step 104), having previously re-enabled all the keypad keys except for the “BIS” key (step 102) in the event of passage via the step 115.

In step 114, test the delay of feedback signal from access means 5a-7a. If the allowed reception delay has not yet elapsed, then return to step 109.

In step 115, either the feedback message indicates that the preceding message from the badge 14 to the access means 5a-7a was received incorrectly, or the reception delay allowed for a feedback signal has elapsed. In either case, display it on the badge 14 by sending a status signal 14c “INCORRECT FEEDBACK” (for example turn on the light-emitting diode 41).

In step 116, disable all the keys of the keypad of the mobile customer badge 14, except for the “BIS” key, which becomes the only active key (in the step 102).

In step 117, wait for customer 2 or 3 to press the “BIS” key to send back the preceding instruction in step 107.

In step 118, if the server 1 is the recipient of the customer instruction, then use the corresponding subroutine, before awaiting a new instruction from the customer (step 104). Depending on the embodiment chosen, this step can be used by the customer 2 or 3 to locate the access means 5a-7a by interrogating the server 1. These calls are set up via the transmission means 19.

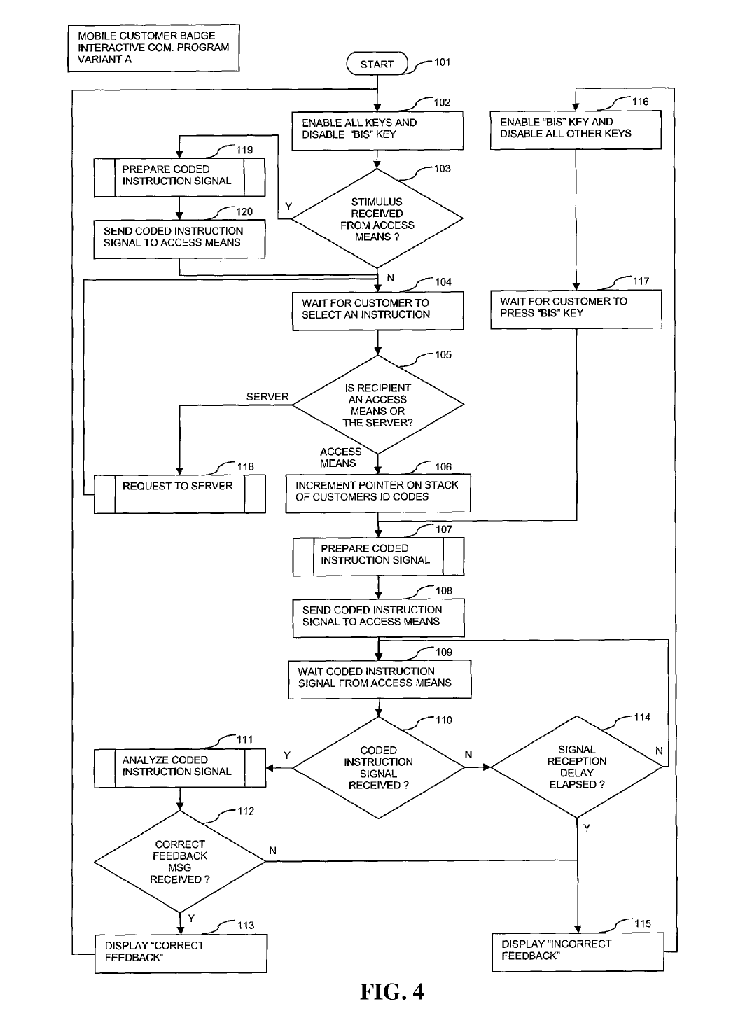

FIG. 4 describes the interactive communication of the mobile customer badge 14 or 15, in a variant A enabling the access means 5a-7a to call the mobile customer badge 14 or 15.

All the steps of FIG. 4 are identical to those of FIG. 3, except:

In step 103, if no stimulus (audio-frequency signal, for example, or coded instruction signal as hereinafter), is received from the access means 5a-7a, then go to step 104 as in FIG. 3. Depending on the embodiment chosen, this type of stimulus can be of the same nature as a coded instruction signal or not.

In step 119, call the subroutine for preparing a coded instruction signal for preparing a feedback message to the access means 5a-7a.

In step 120, send the coded instruction signal 16 to the access means 5a-7a and then return to the step 104 of awaiting a new instruction from the customer.

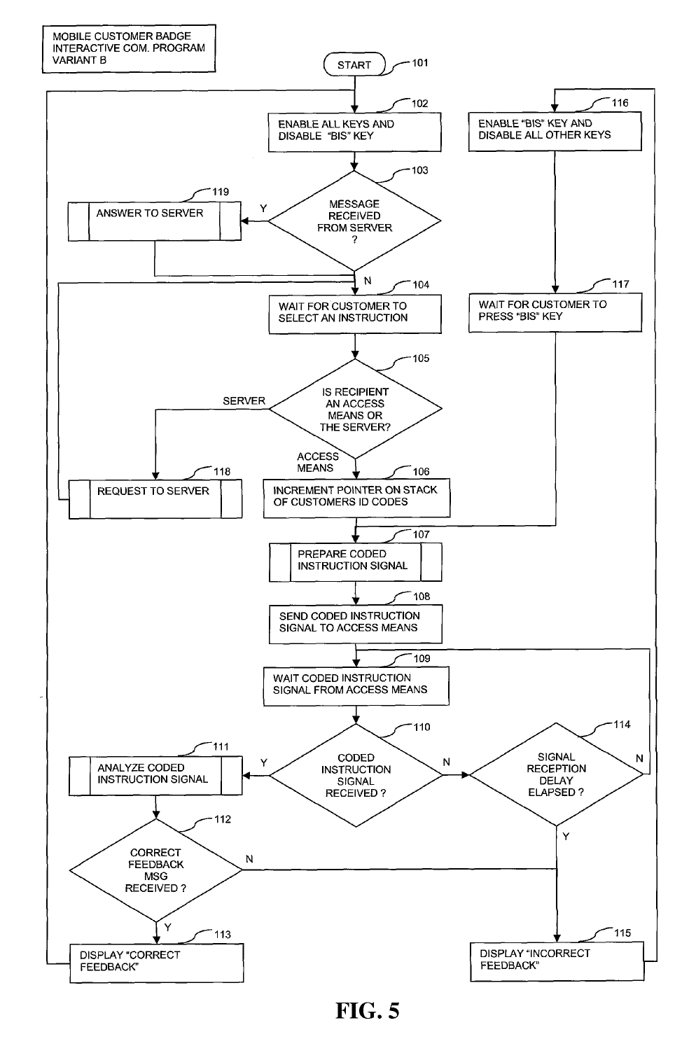

FIG. 5 describes the interactive communication of the mobile customer badge 14 or 15, in a variant B that enables the server means 1 to call the mobile customer badge 14 or 15 via the feedback return means 19.

All the steps are identical to those of FIG. 3, except:

In step 103, if a message has been received from the server 1, then go to step 119; if not, go to step 104.

In step 119, call the subroutine for responding to a call from the server 1 via the feedback transmission means 19. Then return to the step 104 of awaiting a new instruction from the customer.

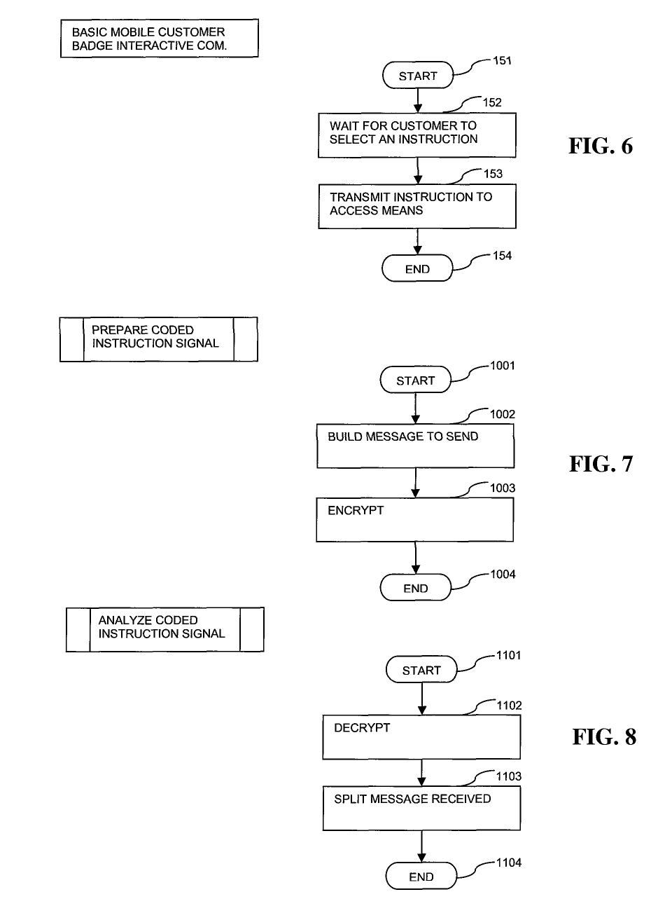

FIG. 6 describes the interactive communication of the mobile customer badge 14 or 15 where, in a first embodiment, this “basic” badge is a magnetic stripe, optical stripe or smart card.

In step 152, await an instruction from the customer by pressing a key on the customer's mobile badge.

In step 153, advise the access means (including a “basic” mobile badge reader) that the customer has sent an instruction.

FIG. 7 describes the subroutine for preparing a coded instruction signal between a mobile customer badge 14 or 15 and access means 5a-7a regardless of the direction.

In step 1002, build the message to send, incorporating in it the following elements, according to the recipient:
a) Coded instruction signal 16 (mobile customer badge 14 or 15 to access means 5a-7a): a specific instruction 16b, a customer identification code extracted from the stack 14d, 15d of customer identification codes, which will be processed by the server 1, and depending on the embodiment chosen, possibly a time of generation of the instruction, or even the identifier of the badge. An identification code of the mobile customer badge can also be transmitted (in the case of recognition of a fingerprint on the badge, for example).
b) Feedback signal 21 (access means 5a-7a) to mobile customer badge 14 or 15): feedback message “CORRECT FEEDBACK” or “INCORRECT FEEDBACK”, and possibly identification code of the access means 5a-7a.

In step 1003, perform optional encryption (cf. optional decryption in step 1102 in FIG. 8).

FIG. 8 describes the subroutine for analyzing a coded instruction signal between a mobile customer badge or an access means 5a-7a regardless of the direction.

In step 1102, perform optional decryption (cf. optional encryption in step 1003 of FIG. 7).

In step 1103, analyze the received signal to extract from it the following data:
a) Coded instruction signal 16 (mobile customer badge 14 or 15 to access means 5a-7a): a specific instruction 16b, a customer identification code extracted from the stack 14d, 15d of customer identification codes, which will be processed by the server 1, and depending on the embodiment chosen, possibly a time of generation of the instruction, or even the identifier of the badge. An identification code of the mobile customer badge can also be transmitted (in the case of recognition of a fingerprint on the badge, for example).
b) Feedback signal 21 (access means 5a-7a) to mobile customer badge 14 or 15): feedback message “CORRECT FEEDBACK” or “INCORRECT FEEDBACK”, and possibly identification code of the access means 5a-7a.

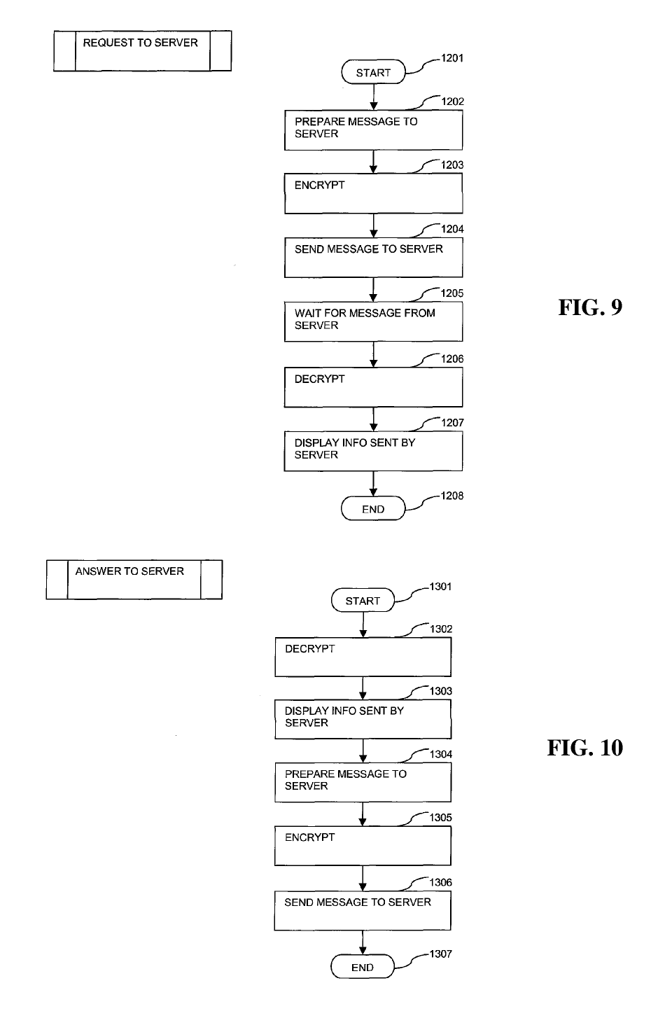

FIG. 9 describes the subroutine for interrogation of the server 1 by a mobile customer badge or access means 5a-7a regardless of the direction. Calls from the mobile customer badge to the server 1 are set up via the transmission means 19. Calls from the access means 5a-7a to the server 1 are set up via the communication network 8.

In step 1202, build a message to send to the server 1.

In step 1203, perform optional encryption (cf. also step 1206).

In step 1204, send the message to the server 1, an instruction for example. In one embodiment, the telephone network of the cellular telephones can be used.

In step 1205, await a message from the server 1.

In step 1206, perform optional decryption (cf. also step 1203).

In step 1207, use the information sent by the server. Depending on the embodiment chosen, this is information on nearby display means, audiovisual messages 4, processing of an order to pay, etc.

FIG. 10 describes the subroutine for response to the server 1 by a mobile customer badge 14 or 15. Calls from the mobile customer badge to the server 1 are set up via the transmission means 19.

In step 1302, perform optional decryption (cf. also step 1305).

In step 1303, use the information sent by the server. Depending on the embodiment chosen, this is information on nearby display means, audiovisual messages 4, processing of an order to pay, etc.

In step 1304, build a message to send to the server 1, for example an instruction, or a follow-up call 18.

In step 1305, perform optional encryption (cf. also step 1302).

In step 1306, send the message to the server 1. In one embodiment the telephone network of the cellular telephones can be used.

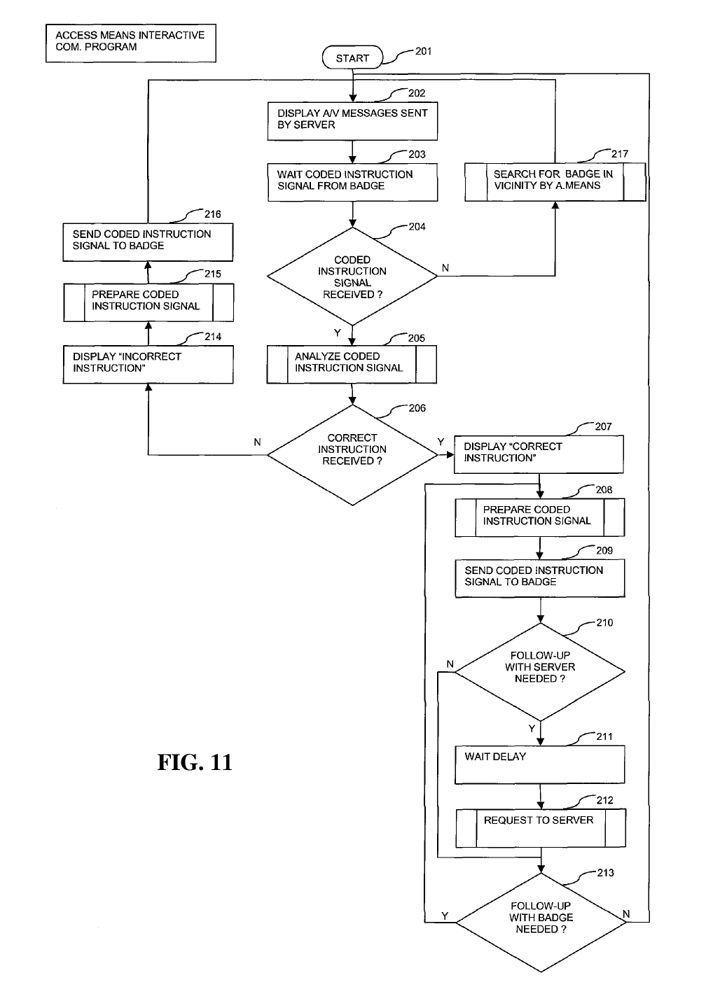

FIG. 11 describes the interactive communication program of the access means 5a-7a via the communication network 8.

In step 202, display on the display means 5-7 audiovisual messages 4 sent by the server 1.

In step 203, await a coded instruction signal from a mobile customer badge 14 or 15.

In step 204, test reception from a mobile customer badge 14 or 15. If no signal has been received yet, go to step 217.

In step 205, if an instruction signal has been received from a mobile customer badge 14 or 15, call the subroutine for analyzing that signal.

In step 206, test validity of instruction message received. If the instruction message has been received incorrectly, go to step 214.

In step 207, if the instruction message is correct, display it on display means 5-7, or possibly even on the mobile customer badge.

In step 208, call the subroutine for preparing a coded instruction signal.

In step 209, send the coded feedback signal to the mobile customer badge 2 or 3.

In step 210, test follow-up by the server 1 as a function of the instruction received.

In step 211, possibly wait if the follow-up with the server 1 must be deferred.

In step 212, call the subroutine for interrogating the server 1.

In step 213, test for possible follow-up with the mobile customer badge 2 or 3 by returning to the step 208. If not, return to the step 202.

In step 214, if the instruction message from the mobile customer badge 2 or 3 has been received incorrectly, display it on the display means 5-7, or possibly even on the mobile customer badge.

In step 215, prepare a feedback coded instruction signal to the badge to send the signal “INCORRECT FEEDBACK”.

In step 216, send the coded instruction signal to the badge.

In step 217, depending on the embodiment chosen, this step is optional, and enables the access means to call nearby mobile customer badges 2 or 3 by calling the corresponding subroutine.

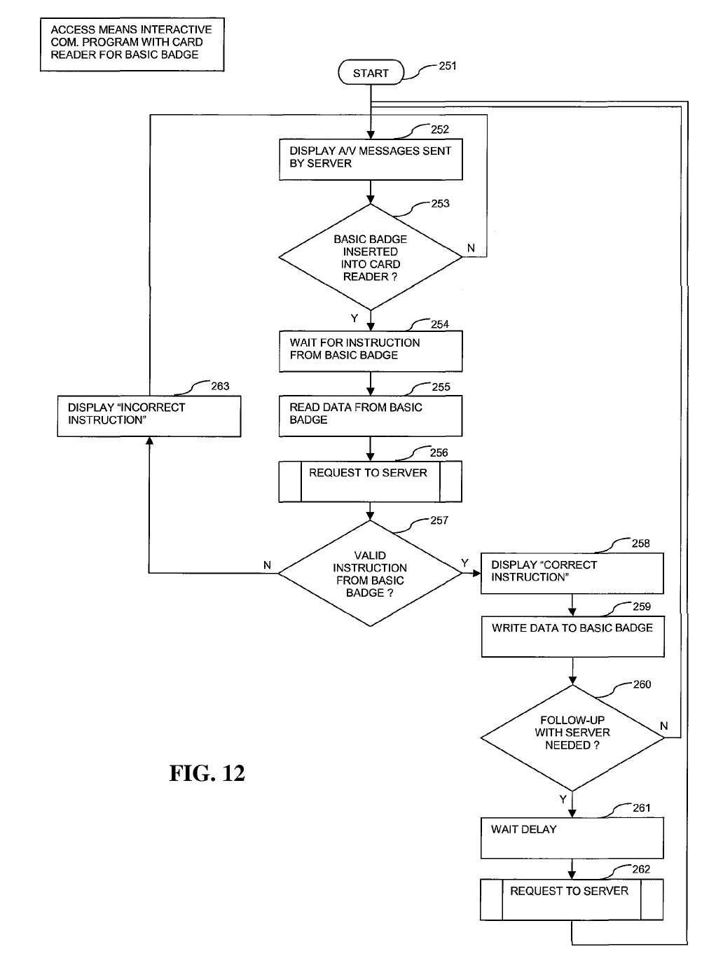

FIG. 12 describes the interactive communication program of the access means 5a-7a, if it includes a card reader, for example for communicating with a “basic” mobile customer badge (cf. FIG. 6). Note that, in this “basic” mobile badge configuration the access means cannot call the nearby mobile customer badges 2 or 3 as described in step 217 of FIG. 11.

In step 252, display on the display means 5-7 audiovisual messages 4 sent by the server 1.

In step 253, test insertion of a “basic” mobile customer badge. If not, continue display in step 252.

In step 254, await an instruction from the “basic” mobile customer badge.

In step 255, read information stored in the badge, possibly with different processing if data illegible. Read in particular the new valid customer identification code 16a (code of immediately higher rank to that of the last instruction (cf. step 258)).

In step 256, call a subroutine for interrogating the server 1 on the validity of the instruction, in particular on the customer identification code 16a.

In step 257, test the validity of the received instruction. If the instruction is invalid, go to the step 263.

In step 258, if the instruction is valid, display it on display means 5-7.

In step 259, write information in the badge, if necessary, in particular indicate that the customer identification code 16a used in step 256 is now not usable for another instruction.

In step 260, test possible follow-up by the server 1 as a function of the instruction received.

In step 261, possibly wait if the follow-up by the server 1 must be deferred.

In step 262, call the subroutine for interrogating the server 1.

In step 263, if the instruction is invalid, display it on display means 5-7, and return to step 252.

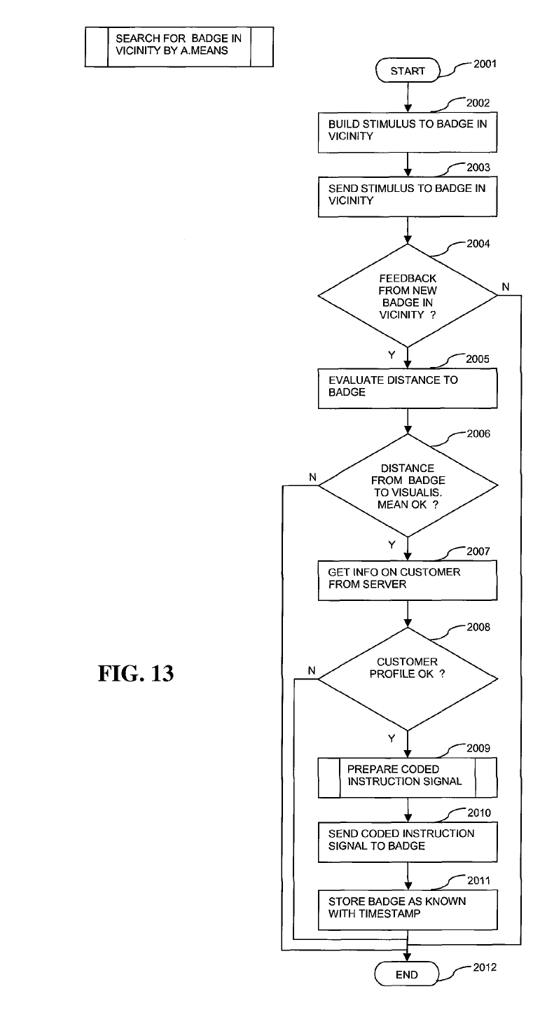

FIG. 13 describes the subroutine for calling by the access means 5a-7a of a mobile customer badge 14 or 15. This subroutine is optional depending on the embodiment chosen.

In step 2002, build a stimulus to go to the nearby mobile customer badges 2 or 3. Depending on the embodiment chosen, this stimulus will be the same as the coded instruction signal exchanged with the mobile customer badge 2 or 3.

In step 2003, send the stimulus to the nearby mobile customer badges 2 or 3.

In step 2004, test any signal from a mobile customer badge 2 or 3 in response to the call. If this badge has already been called (cf. step 2011), compare the stored call time and the present time to avoid calling the same customer again after a short time interval. If not, go to step 2012 to finish the subroutine.

In step 2005, if feedback from a mobile customer badge 2 or 3 is picked up, the access means can, depending on the embodiment chosen, possibly evaluate the distance to the badge, or relay the request to the server 1, which possibly has information on the geographical location of the badge.

In step 2006, test if the access means offer their services or not as a function of the distance between the display means 5-7 and the identified mobile customer badge. If the distance is judged too great, then abandon the call and go to step 2012.

In step 2007, the access means interrogates the server 1 to obtain information on the customer, in order to refine its response.

In step 2008, test if the access means offers their services or not as a function of the customer preferences or profile. If not, abandon the call and go to step 2012.

In step 2009, call the subroutine for preparing a coded instruction signal.

In step 2010, send the coded feedback signal to the mobile customer badge 2 or 3.

In step 2011, store the identified customer mobile badge, with the call time. This record is used in step 2004 to prevent calling unnecessarily a badge recently identified.

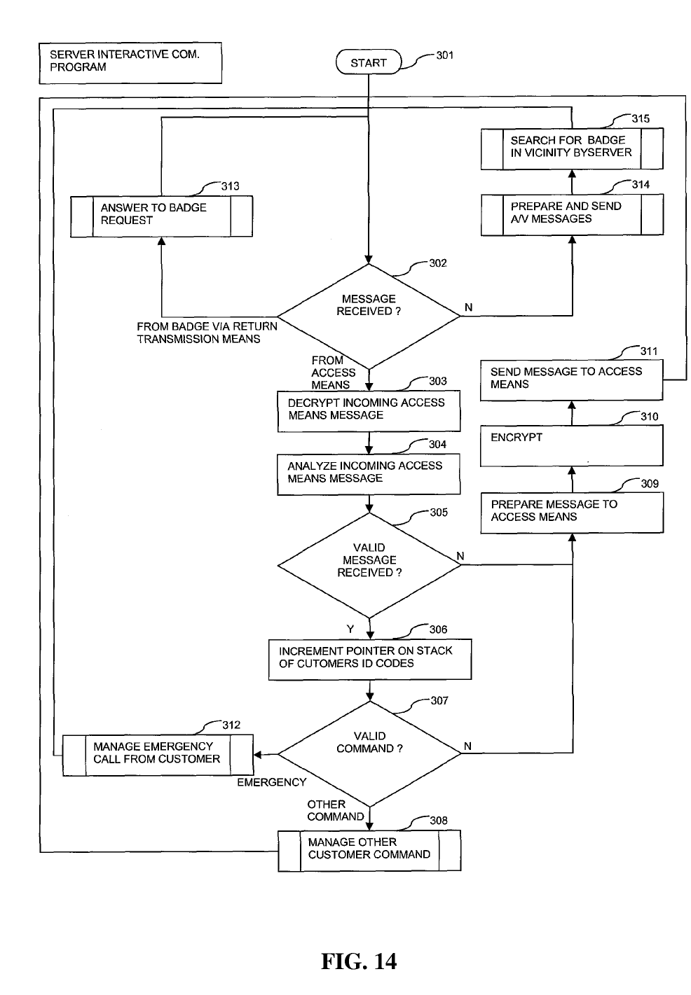

FIG. 14 describes the interactive communication program of the server 1.

In step 302, test if a message has been received: if a message has been received from the badge via the transmission means 19, go to step 313. If a message has been received from access means, go to step 303. If not (if no message has been received), go to step 314.

In step 303, perform optional decryption.

In step 304, the server 1 verifies the validity of the instruction message 17 received:
The field 5b designating the access means against the area 12 of the means for display of messages to be broadcast,
The field 16a designating the customer identification code against the area 24 of the customer identification code stacks for that customer. Where appropriate, a tolerance is authorized by the server 1 of a few customer identification codes of immediately higher rank in its own stack of customer identification codes.
The server also searches the area 10 for messages to be broadcast, the audiovisual message 4 corresponding to the generation time 17a.

In step 305, test the validity of the received message. If invalid, go to step 309.

In step 306, indicate that the next customer identification code will be the immediately higher code in the area 24 of the stack of customer identification codes of each mobile customer badge. This serves to prepare a next call with the same mobile badge via the access means 5a-7a.

In step 307, test the validity of the received customer command. If the command is incorrect, go to step 309; otherwise, if the command is an emergency command, go to step 312.

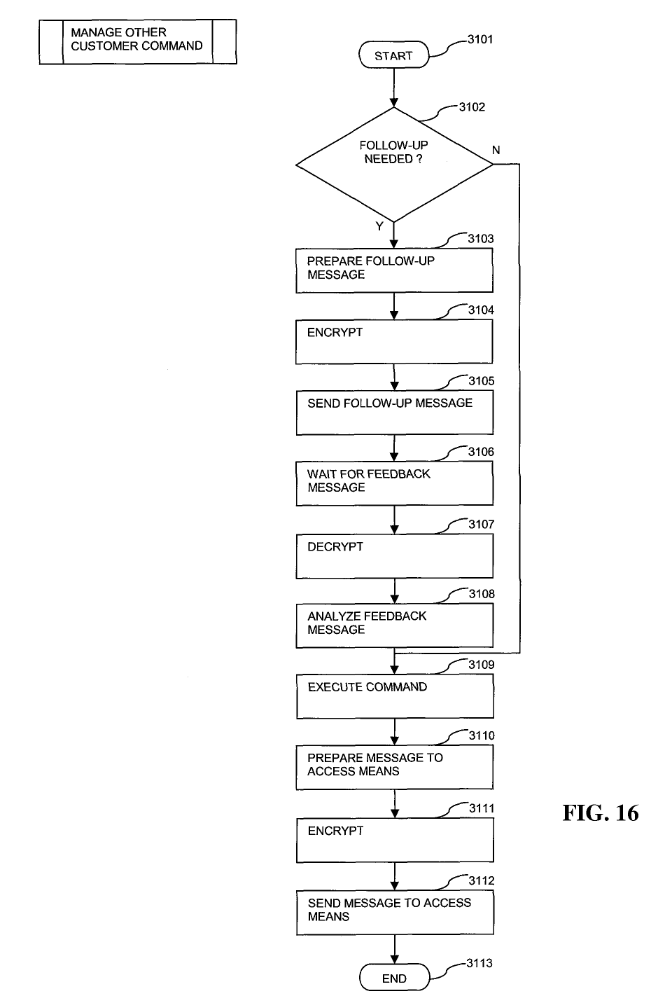

In step 308, call the subroutine for managing valid commands apart from the emergency command (cf. FIG. 16).

In step 309, prepare a feedback message for the access means, to go to the mobile customer badge.

In step 310, perform optional encryption.

In step 311, send the composed message to the access means 5a-7a.

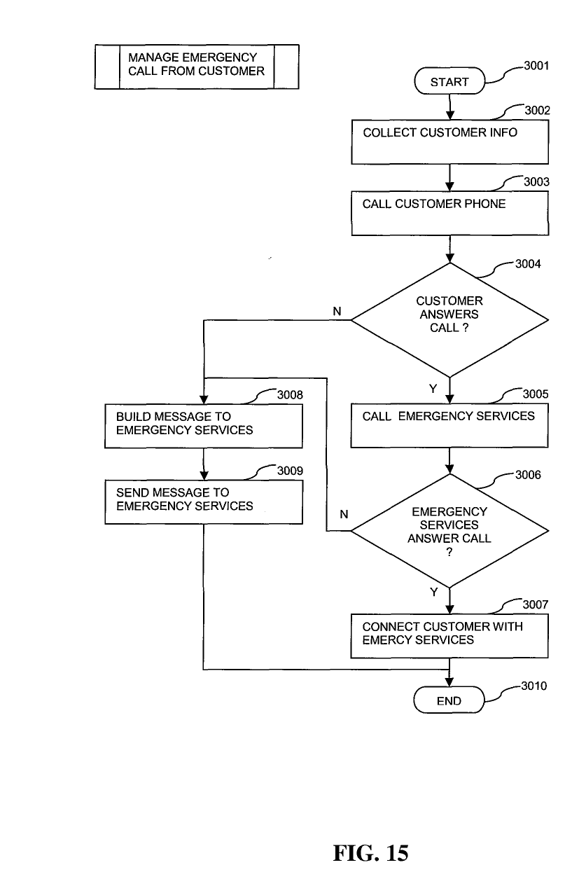

In step 312, if the instruction is an emergency call, then call the emergency call processing subroutine (cf. FIG. 15).

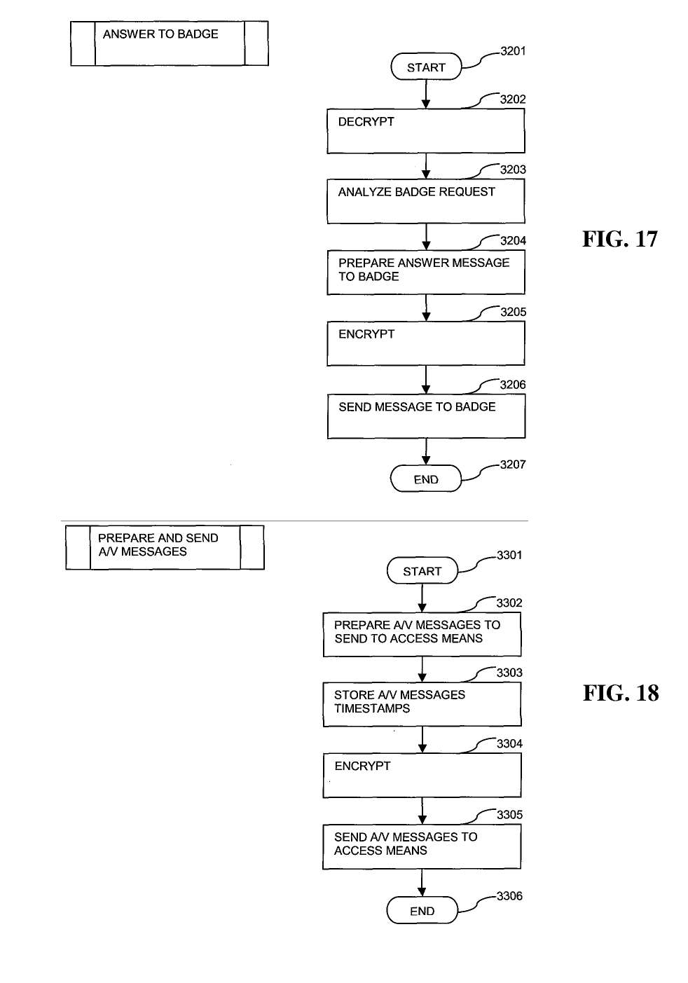

In step 313, if the message has been received from the mobile customer badge via the feedback transmission means 19, then call optional subroutine (depending on embodiment chosen) for responding to the interrogation of the server 1 by the badge (cf. FIG. 17).

In step 314, call the subroutine for preparing and sending audiovisual messages to the access means 5a-7a (cf. FIG. 18).

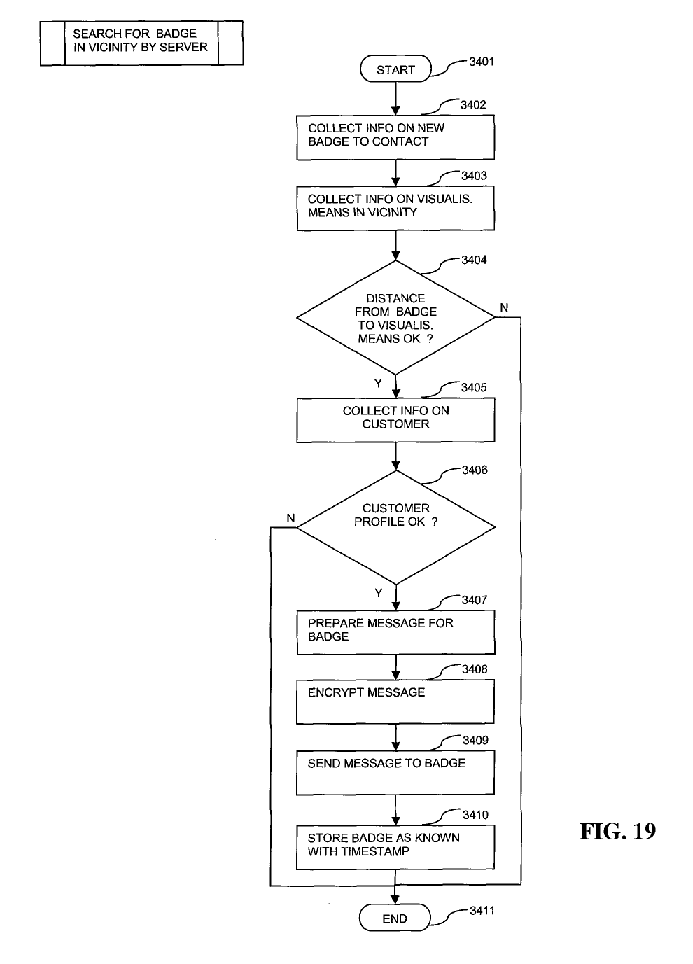

In step 315, call the optional subroutine (depending on the embodiment chosen) for calling mobile customer badges near one or more display means 5-7 via transmission means 19 (cf. FIG. 19).

FIG. 15 describes the subroutine for emergency calls by the customers on their mobile customer badge 14 or 15.

In step 3002, the server system 1 recovers the information relating to the customer, to the geographical situation of the access means 5a-7a or possibly directly from the customer if the server has information on the geographical location of the mobile customer badge used.

In step 3003, the server system 1 generates a telephone call to the customer as a function of the telephone coordinates collected in step 3002.

In step 3004, test the response of the customer to the telephone call. If no answer, go to step 3008.

In step 3005, if the customer has answered, call the emergency services nearest the customer as a function of the information collected in step 3002.

In step 3006, test the response of emergency services to the telephone call. If no response, go to step 3008.

In step 3007, connect the customer to the nearest emergency services.

In step 3008, construct a message to the emergency services nearest the customer, including the information collected in step 3002, where appropriate with the location of the customer.

In step 3009, send the message to the emergency services nearest the customer, in the form of a telephone, facsimile or electronic mail message, for example.

FIG. 16 describes the subroutine for managing valid commands apart from the emergency command.

In step 3102, test to determine if a follow-up message 18 is needed or not as a function of the command entered. Where applicable, if the command is a payment request, this test can determine, as a function of the customer profile, that follow-up is not necessary below a certain amount and obligatory above it. If not, go to step 3109.

In step 3103, prepare the follow-up message.

In step 3104, perform optional encryption (cf. also step 3107).

In step 3105, send the follow-up message via the feedback transmission means 19.

In step 3106, await a feedback message.

In step 3107, perform optional decryption (cf. also step 3104).

In step 3108, analyze the feedback message.

In step 3109, execute the command: for example shipping request.

In step 3110, prepare a feedback message to the access means 5a-7a.

In step 3111, perform optional encryption.

In step 3112, send the feedback message to the access means 5a-7a via the communication network 8.

FIG. 17 describes the optional subroutine depending on the embodiment chosen for responding to interrogation of the server 1 by the badge.

In step 3202, perform optional decryption (cf. also step 3205).

In step 3203, extract the request sent by the badge. This is typically an enquiry from the badge to the server to find out the display means nearest the customer (possibly with a particular type of display means specified, and according to a specified distance).

In step 3204, compose the message to send to the badge.

In step 3205, perform optional encryption (cf. also step 3202).

In step 3206, send the message to the badge via the feedback transmission means 19.

FIG. 18 describes the subroutine for preparing and sending audiovisual messages to the access means 5a-7a.

In step 3302, the server 1 prepares the audiovisual messages 4 to send to the display means 5-7, extracting them from the area 10.

In step 3303, call subroutine 13a for storing time information for sending the audiovisual messages 4. This information is used in feedback to identify to which audiovisual message 4 a customer badge instruction corresponds.

In step 3304, perform optional encryption.

In step 3305, send audiovisual messages 4 to the access means.

FIG. 19 describes the optional subroutine (depending on the embodiment chosen) for calling mobile customer badges near one or more display means 5-7 via transmission means 19.

In step 3402, the server 1 analyzes the customer information area 11 to determine a badge not listed for calling, and its geographical location.

In step 3403, the server 1 analyzes the area 12 of information relating to the display means to determine using their geographical location those near the badge selected in step 3402.

In step 3404, test the distance between the selected badge and the nearest display means 5-7. Where applicable, if this badge has already been called (cf. step 3410), compare the stored call time and the present time to avoid calling the same customer again after a short time interval. Otherwise, go to step 3411 to finish the subroutine.

In step 3405, the server 1 analyzes the customer information area 11 to determine the profile of the customer associated with the listed badge.

In step 3406, test if the server 1 offers its services or not as a function of the preferences of the customer or their profile. If not, abandon the call by going to the step 3411.

In step 3407, prepare an information message to go to the selected mobile customer badge.

In step 3408, perform optional encryption.

In step 3409, send the message via the feedback transmission means 19 to the identified mobile customer badge.

In step 3410, store the identified mobile customer badge, with the call time. This record is used in step 3404 to avoid calling unnecessarily a badge already identified recently.

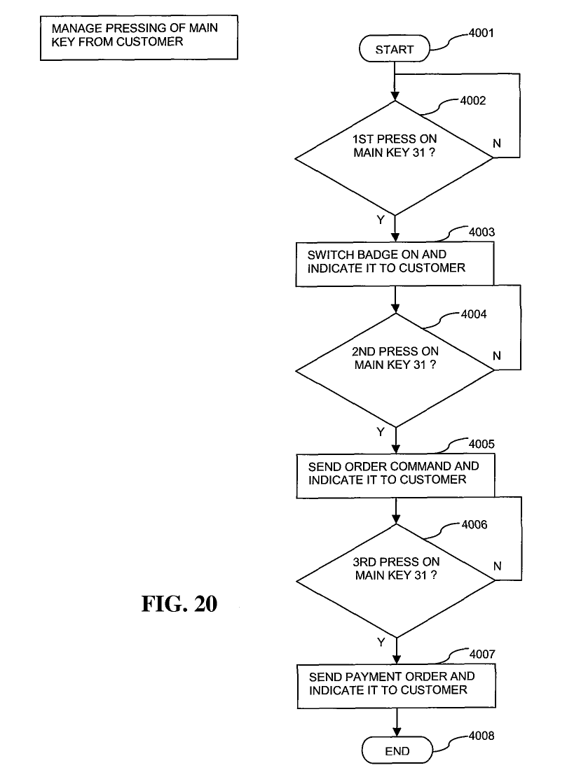

FIG. 20 describes the program for sequencing actions effected by the mobile customer badge as a function of the customer pressing the main key 31.

In step 4002, test to determine if the pressing of the main key 31 of the mobile customer badge is the first one. In the usual embodiments, this key switching the badge on and therefore starting this program, this step is optional. If not, wait in this step until this key is pressed.

In step 4003, switch on the mobile badge and where applicable turn on the light-emitting diode 38.

In step 4004, test to determine if the pressing of the main key 31 of the mobile customer badge is the second one. If not, wait in this step until this key is pressed.

In step 4005, send a command instruction, and where applicable extinguish light-emitting diode 38, and turn on the light-emitting diode 39.

In step 4006, test to determine if the pressing of the main key 31 of the mobile customer badge is the third one. If not, wait in this step until this key is pressed.

In step 4007, send a payment order and where applicable turn off light-emitting diode 39 and turn on light-emitting diode 40.

The present invention is not limited to the embodiments that have been described explicitly and includes variants and generalizations thereof that fall within the scope of the following claims.

What is claimed is:

1. An interactive communication system comprising:
at least one server system, said server system having means for storage of information relating to a plurality of customers,
at least one means for displaying broadcast audiovisual messages, the displaying means being placed at a distance from the server system,
a communication network between the server system and the displaying means,
at least one first access means placed in or near said displaying means with which it is associated,
at least one mobile customer badge assigned to a customer, the mobile customer badge comprising means for entering into the first access means an instruction signal coming from the customer in response to a specific action of the customer,
the mobile customer badge comprising an input interface which enables the customer to enter an instruction chosen from a plurality of possible instructions by an appropriate specific action,
wherein:
the storage means contains additional data necessary for following up customer instructions,
the storage means contains an area for broadcast audiovisual messages,
the storage means contains an interactive communication program,
the system includes a plurality of means for displaying individual broadcast messages,
the communication network comprises means for transmitting broadcast audiovisual messages chosen by the program from the server system to the means for displaying individual broadcast messages,
the instruction signal is a coded instruction signal containing a customer identification code and an instruction chosen by the customer from said plurality of possible instructions,
the first access means comprises means for transmitting, to the server system, via the communication network, an instruction message that contains the instruction chosen by the customer, the customer identification code, an identifier of the display means, and an indication of the time at which the coded instruction signal was sent, and
the program comprises means for combining the coded instruction signal, the identifier of the displaying means, the time of generation of the coded instruction signal, and a remainder of the broadcast messages, to determine the broadcast audiovisual message that was being displayed at the time of generation of the coded instruction signal, and to deduce therefrom an action to be performed.

2. The interactive communication system of claim 1, wherein the displaying means are screens and electroacoustic transducers for presenting audiovisual messages placed at positions making them perceptible by the customers.

3. The interactive communication system of claim 1, wherein the mobile customer badge comprises an input interface enabling the customer to enter an instruction chosen from a plurality of possible instructions by an appropriate specific action.

4. The interactive communication system according to claim 3, wherein the mobile customer badge comprises a plurality of keys each corresponding to a specific instruction and which, when pressed, generate the coded instruction signal containing the corresponding specific instruction.

5. The interactive communication system of claim 4, wherein one of the keys may be operated more than once in succession to generate successively an order instruction and then a payment instruction.

6. The interactive communication system of claim 4, wherein the mobile customer badge comprises at least one key associated with a fingerprint recognition device and the interactive communication system comprises means for inhibiting execution of the specific instruction in the event of non-recognition of one or more fingerprints previously stored by the customer.

7. The interactive communication system of claim 3, wherein:
the mobile customer badge is a magnetic stripe card, an optical stripe card or a microchip card in which the customer identification code is stored,
the first access means is a card reader capable of reading the customer identification code in a card that is presented to it.

8. The interactive communication system of claim 3, wherein:
the mobile customer badge comprises an electromagnetic signal sender capable of sending the coded instruction signal in the form of a coded electromagnetic signal in response to a specific action of the customer, and
the first access means is an electromagnetic signal receiver capable of receiving said coded electromagnetic signal and of extracting therefrom the customer identification code and the instruction corresponding to the specific action of the customer.

9. The interactive communication system according to claim 8, wherein the mobile customer badge is a cellular mobile telephone.

10. The interactive communication system of claim 8, wherein:
the mobile customer badge is capable of receiving electromagnetic acknowledgment signals,
the first access means comprises a sender and means for generating and sending an electromagnetic acknowledgment signal after reception of a coded instruction signal from the mobile customer badge, and
the mobile customer badge is capable of emitting a status signal perceptible by the user and indicating whether the first access means has received the coded instruction signal correctly.

11. The interactive communication system according to claim 1, further comprising a return transmission means for directly setting up a follow-up call to the customer from the server system or a service provider system designated by the server system,
wherein the program is capable of choosing and setting up the follow-up call as a function of the coded instruction signal received from the customer and information contained in the storage means.

12. The interactive communication system of claim 11, wherein the return transmission means is a cellular mobile telephone network of a cellular mobile telephone.

13. The interactive communication system of claim 11, wherein the return transmission means is a means for transmitting text messages, such as the postal service, electronic mail, facsimile, electronic messages.

14. The interactive communication system of claim 11, wherein the program comprises means for launching execution of the customer's specific instruction directly without setting up a follow-up call if the instruction involves a financial transaction whose amount is below a predefined threshold.

15. The interactive communication system according to claim 11, wherein the server system comprises a voice recognition device associated with the return transmission means and means for inhibiting execution of the specific instruction in the event of non-recognition of the previously recorded voice of the customer.

16. The interactive communication system according to claim 1, wherein a subroutine contained in said program comprises means for instructing the server system to store the time of transmission to each display means of each broadcast audiovisual message.

17. The interactive communication system according to claim 1, wherein:
the mobile customer badge contains a stack of customer identification codes stored in a memory of the mobile customer badge in a random order,
the server system contains the same stack of customer identification codes stored in the same random order in a memory of the server,
the mobile customer badge comprises means for associating with each specific instruction the next higher customer identification code in the stack of customer identification codes, and
the server comprising means, on each reception of an instruction message, for comparing the customer identification code received with the next higher customer identification code in its own stack of customer identification codes and for inhibiting execution of the customer's specific instruction if they are different.

18. The interactive communication system according to claim 1, wherein the coded instruction signals and/or the instruction messages are encrypted using keys distributed in a random selection mode.

19. An interactive communication system comprising:
at least one server system, said server system having means for storage of information relating to a plurality of customers,
at least one means for displaying broadcast audiovisual messages, the displaying means being placed at a distance from the server system,
a communication network between the server system and the displaying means,
at least one first access means placed in or near said displaying means with which it is associated,
at least one mobile customer badge assigned to a customer, the mobile customer badge comprising means for entering into the first access means an instruction signal coming from the customer in response to a specific action of the customer, the badge including a dedicated key for signaling an emergency,
the mobile customer badge comprising an input interface which enables the customer to enter an instruction chosen from a plurality of possible instructions by an appropriate specific action,
wherein:
the storage means contains additional data necessary for following up customer instructions,
the storage means contains an area for broadcast audiovisual messages,
the storage means contains an interactive communication program,
the system includes a plurality of means for displaying individual broadcast messages,
the communication network comprises means for transmitting broadcast audiovisual messages chosen by the program from the server system to the means for displaying individual broadcast messages,
the instruction signal is a coded instruction signal containing a customer identification code and an instruction chosen by the customer from said plurality of possible instructions,
the first access means comprises means for transmitting, to the server system, via the communication network, an instruction message that contains the instruction chosen by the customer, the customer identification code, and an identifier of the display means,
and wherein the dedicated key comprises means for generating a dedicated coded instruction signal to the server system, and wherein the server system comprises means for contacting the customer, and for sending a message to a law enforcement agency nearest the first access means with information about the customer and a location of the first access means, in the event that the customer does not respond to the server system.
